(19) United States
(12) Patent Application Publication
(10) Pub. No.: US 2011/0023562 A1
(43) Pub. Date: Feb. 3, 2011

(54) LAUNDRY TREATING MACHINE

(76) Inventors: Hea Kyung Yoo, Seoul (KR); Sog Kie Hong, Seoul (KR); Dong Won Kim, Seoul (KR); Jong Seok Kim, Seoul (KR); Dae Yun Park, Seoul (KR)

Correspondence Address: MCKENNA LONG & ALDRIDGE LLP, 1900 K STREET, NW, WASHINGTON, DC, 20006, US

(21) Appl. No.: 12/935,382

(22) PCT Filed: Mar. 18, 2009
(86) PCT No.: PCT/KR09/01362

§ 371 Date: Sep. 29, 2010

(30) Foreign Application Priority Data
Apr. 1, 2008 (KR) 10-2008-0030338

(51) Int. Cl. B08B 3/12

(52) U.S. Cl. 68/5 C

(57) ABSTRACT

A control method of a laundry treating machine is disclosed. A laundry treating machine includes a cabinet comprising an accommodating space receiving laundry therein, a hot air supply device heating air to supply hot air to the accommodating space and a communication part communicating the accommodating space with an outside. The present invention relates to a laundry treating machine capable of preventing children from being locked therein and of enhancing performance thereof.

### TECHNICAL FIELD

The present invention relates to a laundry treating machine. More specifically, the present invention relates to a laundry treating machine capable of preventing children from being locked therein and of enhancing performance thereof.

### BACKGROUND ART

Laundry treating machines typically include washing machines, dryers and washing machines having a drying function. In recent, with improvement of standard of living, refreshers have been developed. Here, such a refresher supplies dried air to clothes and cloth items (hereinafter, laundry) received therein.

The laundry treating machines including such the refreshers have a sealed structure to refresh, by extension, remove moisture laundry received therein. Such the sealed structure may improve performance of laundry refreshing and drying.

### DISCLOSURE OF INVENTION

### Technical Problem

However, such the sealed structure may cause a problem that a child who happens to come into the laundry treating machine in a play time cannot escape from the sealed structure of the laundry treating machine. That is, if a child happens to come into the laundry treating machine for fun and a door is closed, the laundry treating machine forms the sealed structure. Then, even if the child pushes the door inside, the door won't be opened and there is danger of being choked.

### Technical Solution

To solve the problems, an object of the present invention is to provide a laundry treating machine having a structure not sealed airtight to prevent a person or child who happens to come into from being choked.

Another object of the present invention is to provide a laundry treating machine capable of improving laundry treating efficiency, with a not-sealed structure.

To achieve these objects and other advantages and in accordance with the purpose of the invention, as embodied and broadly described herein, a laundry treating machine includes a cabinet comprising an accommodating space receiving laundry therein; a hot air supply device heating air to supply hot air to the accommodating space; and a communication part communicating the accommodating space with an outside.

The laundry treating machine may further include a suppressing unit suppressing discharge of air inside the accommodating space.

The laundry treating machine may further include a circulation duct supplying hot air to the accommodating space and circulating the hot air, wherein the communication part is provided along the circulation duct.

The communication part may include an opening formed at the circulation duct to communicate with an outside of the circulation duct.

The laundry treating machine may further include a fan blowing air along the circulation duct, wherein the opening is provided in front of the fan.

The laundry treating machine may further include a heating part of the hot air supply device provided along the circulation duct, wherein the opening is provided between the heating part and the fan along the circulation duct.

The suppressing unit may include a guide formed in an opposite direction to the air flowing along the circulation duct to guide air drawn via the opening, the guide suppressing discharge of air inside the circulation duct.

The laundry treating machine may further include a steam generator supplying steam to the accommodating space along the circulation duct, the circulation duct provided under the accommodating space.

The laundry treating machine may further include a suppressing unit suppressing air flowing via the communication part.

The communication part may include a first hole formed at an inside of a cabinet; and a second hole formed at an outside of the cabinet to communicate with the first hole, and the suppressing unit may include at least one bent communication channel connecting the first and second holes.

The laundry treating machine may further include at least one projection part provided at the communication channel to form a bent portion of the communication channel.

The laundry treating machine may further include a plurality of partition walls provided along the communication channel. Communication holes connecting the first and second holes may be provided at the partition walls, respectively, and the communication holes may be formed alternatively along the communication channel.

The communication part may be formed adjacent to an inner corner of the cabinet.

### ADVANTAGEOUS EFFECTS

The present invention has following advantageous effects.

The laundry treating machine according to the present invention includes the communication part capable of communicating the inside with the outside of the accommodating space. As a result, in case that a person or child happens to come into the laundry treating machine, a danger of being choked may be prevented in advance.

Furthermore, according to the present invention, external air may be drawn into the laundry treating machine and thus efficiency of the laundry treating machine may be enhanced.

A still further, the laundry treating machine includes the communication part capable of communicating the inside with the outside of the accommodating space and thus unpleasant smell or the line may be prevented from permeating the inside of the laundry treating machine.

### BRIEF DESCRIPTION OF DRAWINGS

The accompanying drawings, which are included to provide further understanding of the disclosure and are incorporated in and constitute a part of this application, illustrate embodiments of the disclosure and together with the description serve to explain the principle of the disclosure.

In the drawings:

FIG. 1 is a perspective view illustrating a laundry treating machine according to an exemplary embodiment of the present invention;

FIG. 2 is a diagram schematically illustrating an inner structure of a mechanism compartment shown in FIG. 1;

FIG. 3 is a diagram schematically illustrating a communication part according to a first embodiment;

FIG. 4 is a diagram schematically illustrating a communication part according to a second embodiment;

FIG. 5 is a diagram schematically illustrating a communication part according to a third embodiment; and

FIG. 6 is a sectional view of VI-VI line.

### BEST MODE FOR CARRYING OUT THE INVENTION

Reference will now be made in detail to the specific embodiments of the present invention, examples of which are illustrated in the accompanying drawings. Wherever possible, the same reference numbers will be used throughout the drawings to refer to the same or like parts.

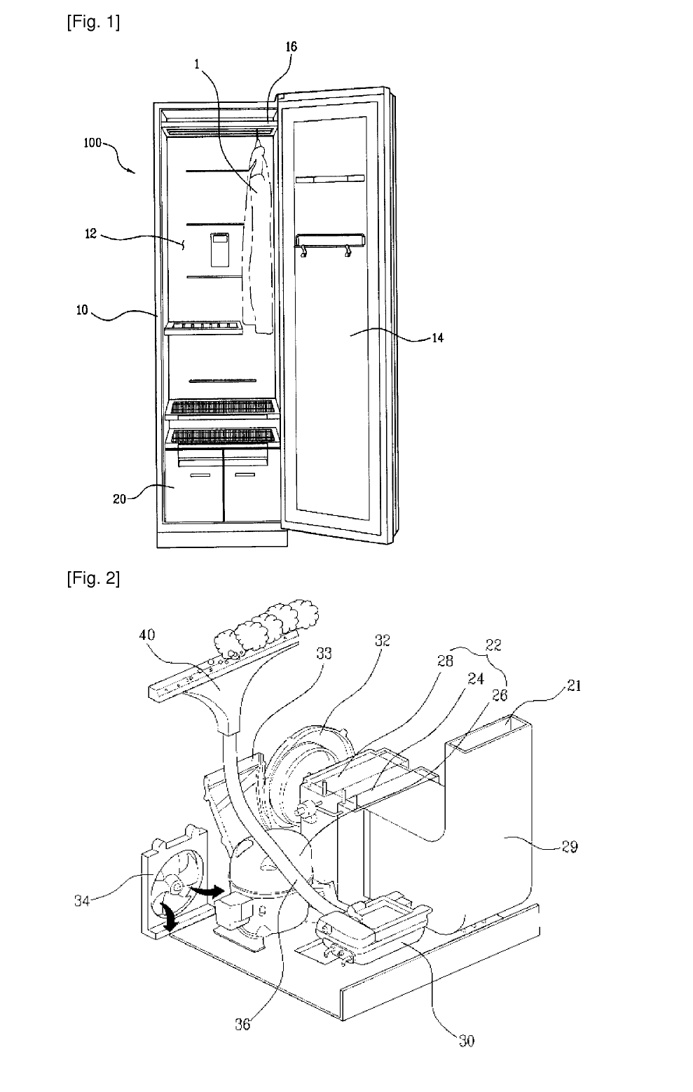

FIG. 1 is a front view illustrating a laundry treating machine according to an exemplary embodiment of the present invention. First of all, a configuration of the laundry treating machine will be described simply and next a communication part communicating an inside with an outside of the laundry treating machine will be described.

In reference to FIG. 1, a laundry treating machine 100 according to the present invention includes a cabinet 10, a hot air supply device (22, see FIG. 2), a circulation duct (29, see FIG. 2) and a communication part 50 The cabinet 10 forms an accommodating space 12 receiving laundry therein. The hot air supply device 22 heats air to supply hot air to the accommodating space 12. The circulation duct 29 supplies hot air heated by the hot air supply device 22 and circulates the hot air. The communication part 50 draws external air.

In the cabinet 10 are provided various elements which will be described later and is formed the accommodating space 12. Such the accommodating space 12 is selectively in communication with an outside by a door 14. Various supporters 16 on which laundry 1 including clothes are hung are provided in the accommodating space 12. This configuration of supporting the laundry 1 is well-known in the art to which the present invention pertains and the detailed description thereof will be omitted accordingly.

A mechanism compartment 20 may be formed in the cabinet 10 and the hot air supply device 22 capable of selectively supplying hot air to the accommodating space 12 is mounted in the mechanism compartment 20. The mechanism compartment 20 may be provided under the accommodating space 12 and the hot air supply device 22 is provided in the mechanism compartment 20. The reason why the mechanism compartment 20 is provided under the accommodating space 12 is that the dried air supplied to the accommodating space 12 is substantially high temperature air tending to ascend upward. It is preferable that dried air is supplied upward from the mechanism compartment 20 positioned under the accommodating space 12.

FIG. 2 is a perspective view schematically illustrating an inner structure of the mechanism compartment 20.

In reference to FIG. 2, a heat pump 22 may be provided in the mechanism compartment 20 as the hot air supply device supplying hot air to the accommodating space (12, see FIG. 1).

The heat pump 22 corresponding to the hot air supply device of the present invention may be substantially similar to a heat pump used in air conditioners. That is, the heat pump includes an evaporator 24, a compressor 26, a condenser 28 and an expansion valve (not shown), through which refrigerant is circulated sequentially to dehumidify and heat air. Specifically, the evaporator 24 evaporates refrigerant and absorbs latent heat of ambient air, such that the air is cooled to condense moisture contained in the air. If the refrigerant having passed the compressor 26 is condensed in the condenser 28, the latent heat is exhausted toward ambient air and the ambient air is heated. As a result, the evaporator 24 and the condenser 28 have a heat-exchanging function, such that the air supplied to the mechanism compartment 20 may be dehumidified and heated to be re-supplied to the accommodating space 12, passing the evaporator 24 and the condenser 28.

Specifically, an inlet 21 may be formed at a top of the mechanism compartment 20 and air inside the accommodating space 12 is drawn into the mechanism compartment 20 via the inlet 21. A path may be formed by a circulation duct 29 connecting the condenser 28 and a fan 32 and the air is passed along the path. The air drawn into the mechanism compartment 20 by the circulation duct 29 via the inlet 21 may be dehumidified and heated, passing the heat pump 22, and then the air may be re-supplied to the accommodating space 12 via an outlet 33 by the fan 32.

Although not shown in the drawings, a filter may be provided at the inlet 21. The filter provided at the inlet 21 may filter various foreign substances which might be contained in the air supplied to the mechanism compartment 20 and only fresh air can be re-supplied to the accommodating space 12.

The mechanism compartment 20 may further include the steam generator 30 to supply steam to the accommodating space 12.

Wrinkles which might be generated on the laundry may be removed as steam is supplied to the accommodating space 12 by the steam generator 30. Moreover, a sanitary and sterilization effect because of the high temperature steam, and a refresh effect because of fabric bulk may be expected.

The steam generator 30 includes the heater 40 and the water inside the steam generator 30 is heated by the heater 40 such that steam is generated to be supplied to the accommodating space 12. A water supply source supplying water to the steam generator 30 may be an external water tap or a container type provided in the mechanism compartment 20. Such the container type water supply source may be separable from the cloth treating apparatus. Then, the user separates the water supply source from the mechanism compartment 20 and fills up with water and after that, the user re-install the water supply source back in the mechanism compartment 20. The steam generated by the steam generator 30 is supplied to the accommodating space 12 via a steam hose 36 and a steam nozzle 40. Here, the shorter the steam hose 36 is, the more preferable it is such that the temperature of the steam may be prevented from decreasing or the steam is prevented from being condensed. If the mechanism compartment 20 is provided under the accommodating space 12, the steam nozzle 40 may be positioned at a top of the mechanism compartment, that is, a bottom of the accommodating space 12 to supply steam. In addition, a circulation fan 34 may be provided in a rear of the mechanism compartment 20. The circulation fan 34 blows external air of the mechanism compartment 20 into the mechanism compartment 20 to cool the heat pump 22, especially, the compressor 26 of the heat pump 22 and to prevent the temperature inside the mechanism compartment 20 from increasing too much.

As mentioned above, the laundry treating machine according to this embodiment includes the communication part capable of drawing external air into the accommodating space 12. because of the communication part, the configuration including the accommodating space 12 and the circulation duct 29 may not form a sealed structure such that a danger of being choked could be prevented in case that a person including a child happens to come into the laundry treating machine. According to the laundry treating machine according to this embodiment, hot air or steam, if being supplied to the accommodating space 12, may not be discharged outside of the accommodating space 12, even with external air being drawn into both of the accommodating space 12 and the circulation duct 29. Next, this configuration will be described in detail.

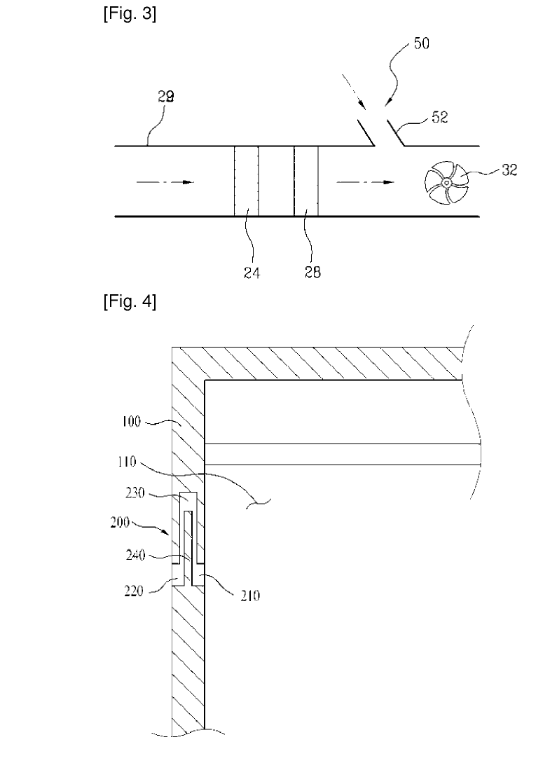

FIG. 3 schematically illustrates a communication part 50 according to a first embodiment.

In reference to FIG. 3, the communication part 50 according to the first embodiment may be an opening 50 formed at the circulation duct 29 to communicate with an outside of the circulation duct 20. That is, the space including the accommodating space 12 and the circulation duct 29 may include the opening 50 formed at a predetermined portion of the circulation duct, being in communication with the outside, such that the space may not form a sealed structure.

Such the opening 50 is provided at the circulation duct 29, preferably, at the predetermined portion of the circulation duct in front of a circulation fan 32 provided at an end of the circulation duct 29. The reason why the opening 50 is positioned in front of the circulation fan 32 is that external air of the circulation duct 29 is smoothly drawn into the circulation duct 29 by the operation of the circulation fan 32.

In addition, if the heat pump is provided as the hot air supply device 22, the circulation duct 29 may include the evaporator 24 and the condenser 28 employed as the heating parts heating the circulating air. Here, the opening 50 may be provided between the heating parts (24 and 28) and the circulation fan 32.

The opening 50 may be provided in front of the heating parts along the circulation duct 29. If then, relatively cold external air of the circulation duct 29 will be drawn toward the heating parts and there might be overload of the heating parts because of the amount of the cold air drawn toward the heating parts. As a result, it is preferable that the opening 50 is provided between the heating parts and the circulation fan 32 along the circulation duct 29.

By the way, a guide 52 may be further provided at the circulation duct 29 to guide the air drawn via the opening 50. Such the guide 52 is employed to guide the external air into the circulation duct 29 and it is employed as a suppressing unit capable of suppressing the air inside the circulation duct 29 from being discharged outside.

Specifically, the guide 52 may be formed along a circumference of the opening 50 as shown in the drawing. It is preferable that the guide 52 is formed toward an opposite direction of the air flow along the circulation duct 29. For example, the air is flowing toward the circulation fan 32 from the heating parts 24 and 28 along the inside of the circulation duct 29. In this case, the guide 52 may be oblique toward the heating parts from the opening 50, in order to prevent the air heated by the heating parts 24 and 18 inside the circulation duct 29 from being discharged outside via the opening 50. That is, if the guide 52 is formed toward the circulation fan along the air flow, for example, most of the air heated by the heating parts 24 and 18 would be discharged outside the circulation duct 29 along the opening 50. If then, the dried hot air would not be supplied to the accommodating space 12 only to deteriorate efficiency of the laundry treating machine. according to this embodiment, the opening 50 capable of drawing external air into the circulation duct 29 is provided and the guide 52 capable of preventing the dried hot air inside the circulation duct 29 from being discharged outside is provided simultaneously.

As mentioned above, if the laundry treating machine includes the steam generator 30 spraying steam into the accommodating space 12 selectively, the circulation duct 29 may be provided under the accommodating space 12 to prevent the steam supplied to the accommodating space 12 from being discharged to an outside of the accommodating space 12.

If the circulation duct 29 including the communication part is formed along the top of the accommodating space 12, high temperature steam tending to ascending upward would not flow along the inside of the accommodating space 12 but flow to the outside via the communication part. As a result, the sanitizing, sterilizing or refreshing effect by using supplied steam results in deteriorating noticeably.

Thus, this embodiment presents that the circulation duct 29 including the communication part 50 is provided along a bottom of the accommodating space 12 such that the steam supplied to the accommodating space 12 may not be discharged outside via the opening 50.

FIG. 4 is a side sectional view of the cabinet to illustrate a communication part according to a second embodiment.

In reference to FIG. 4, the communication part 200 according to the second embodiment includes a first hole 210 formed at an inside of the cabinet 100 and a second hole 220 formed at an outside of the cabinet. A communication channel 230 is formed between the first hole 210 and the second hole 220 for air to flow there between.

Such the communication channel 230 communicates the accommodating space 110 formed in the cabinet 100 with an outside. If hot air or steam is supplied to the accommodating space 110, the communication channel 230 may be bent at least one time to prevent the supplied hot air or steam from being discharged to the outside. To form the bent communication channel 230, at least one projection part 240 may be provided along the channel 230.

Such the projection part 240 is formed at a portion of the communication channel 230 between the first hole 210 and the second hole 220 and it is employed as a flow resistance against the air or steam flowing along the communication channel 230. As a result, although the accommodating space 12 is in communication with the outside by the communication channel 230, the air or steam inside the accommodating space 12 may be prevented from being discharged outside without any difficulties.

At this time, a single projection part 240 may be provided but if a plurality of projection parts 240 are provided to allow the communication channel 230 to have a zigzag appearance, the amount of the air which could be discharged from the first hole 210 to the second hole 220 may be reduced efficiently.

The communication part 200 communicating an inside with an outside of the cabinet 100 may be formed adjacent to an inner corner of the cabinet 100. In case that steam or hot air is supplied into the cabinet 100, a dead zone to which the least of the s team or hot air is supplied is formed near the corner of the cabinet 100. If the communication part 200 is formed near such the dead zone, the steam or hot air inside the cabinet 100 may be prevented from being discharged outside as much as possible.

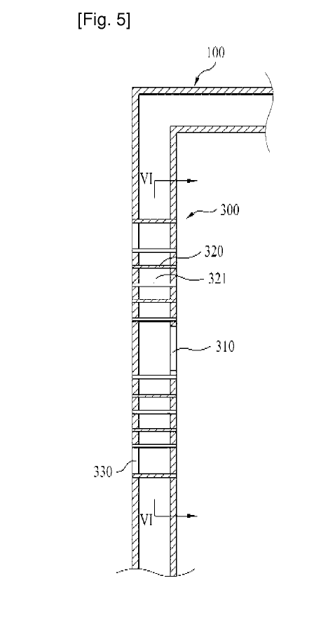

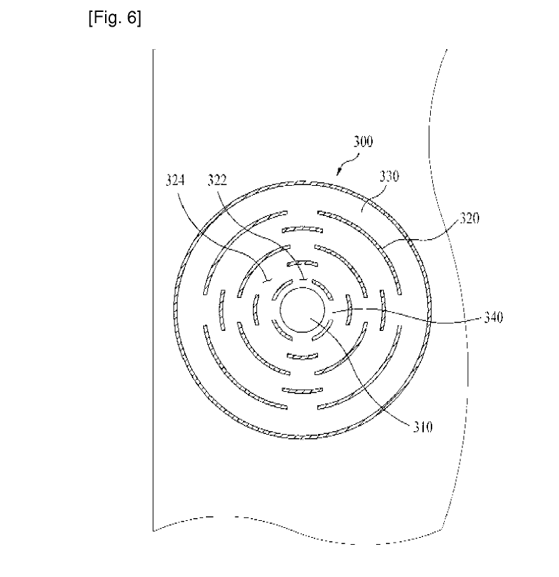

FIG. 5 is a side sectional view partially illustrating the cabinet to show a communication part according to a third embodiment and FIG. 6 is a sectional view along VI-VI line of FIG. 5. Compared with the communication part according to the above second embodiment, the communication part according to this embodiment has a different method of forming the bent communication channel. Next, the difference will be described in detail.

In reference to FIGS. 5 and 6, the communication part 300 according to this embodiment may include a plurality of partition walls 320 to form a bent communication channel 340. for example, such the partition walls 320 may be concentric with respect to the first hole 310, as shown in FIGS. 5 and 6, and the second hole 330 may be provided along an outside of the partition walls 320.

Communication holes 332 and 324 may be formed at the partition walls 320, respectively, to connect the first hole 210 and the second hole 330 and to form the communication channel 340. That is, the communication channel 340 may be formed along the communication holes 322 and 324 formed at the partition walls 320, respectively, and the second hole 330 is connected with the communication channel 340.

Here, it is preferable that the communication holes 322 and 324 are alternatively formed at the partition walls 320. As shown in FIG. 6, a first communication hole 322 and a second communication hole 324 are not formed linearly along a semi-diameter from the first hole 310 but formed alternatively along a semi-diameter to form the bent communication channel 340. When the communication holes 322 and 324 are formed alternatively, the communication channel 340 connecting the communication holes 322 and 324 may be bent, namely, form a labyrinth structure′. Therefore, although the communication part according to this embodiment communicates the inside with the outside of the cabinet 100 like the above embodiments, the air or steam inside the cabinet 100 may not be discharged outside.

The communication part according to the above embodiments is described and it is not limited thereto. That is, the communication part may be variable in many ways.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A laundry treating machine comprising:
a cabinet comprising an accommodating space receiving laundry therein;
a hot air supply device heating air to supply hot air to the accommodating space; and
a communication part communicating the accommodating space with an outside.

2. The laundry treating machine as claimed in claim 1, further comprising:
a suppressing unit suppressing discharge of air inside the accommodating space.

3. The laundry treating machine as claimed in claim 2, further comprising:
a circulation duct supplying hot air to the accommodating space and circulating the hot air, wherein the communication part is provided along the circulation duct.

4. The laundry treating machine as claimed in claim 3, wherein the communication part comprises,
an opening formed at the circulation duct to communicate with an outside of the circulation duct.

5. The laundry treating machine as claimed in claim 4, further comprising:
a fan blowing air along the circulation duct, wherein the opening is provided in front of the fan.

6. The laundry treating machine as claimed in claim 5, further comprising:
a heating part of the hot air supply device provided along the circulation duct, wherein the opening is provided between the heating part and the fan along the circulation duct.

7. The laundry treating machine as claimed in claim 3, wherein the suppressing unit comprises,
a guide formed in an opposite direction to the air flowing along the circulation duct to guide air drawn via the opening, the guide suppressing discharge of air inside the circulation duct.

8. The laundry treating machine as claimed in claim 3, further comprising:
a steam generator supplying steam to the accommodating space along the circulation duct, the circulation duct provided under the accommodating space.

9. The laundry treating machine as claimed in claim 1, further comprising:
a suppressing unit suppressing air flowing via the communication part.

10. The laundry treating machine as claimed in claim 9, wherein the communication part comprises a first hole formed at an inside of a cabinet; and a second hole formed at an outside of the cabinet to communicate with the first hole, and the suppressing unit comprises at least one bent communication channel connecting the first and second holes.

11. The laundry treating machine as claimed in claim 10, further comprising:
at least one projection part provided at the communication channel to form a bent portion of the communication channel.

12. The laundry treating machine as claimed in claim 10, further comprising:
a plurality of partition walls provided along the communication channel, wherein communication holes connecting the first and second holes are provided at the partition walls, respectively, and the communication holes are formed alternatively along the communication channel.

13. The laundry treating machine as claimed in claim 10, wherein the communication part is formed adjacent to an inner corner of the cabinet.
